(19) United States
(12) Patent Application Publication
(10) Pub. No.: US 2018/0153135 A1
(43) Pub. Date: Jun. 7, 2018

(54) PORTABLE PET RESTRAINT

(71) Applicant: The Crateless Co., Jacksonville, FL (US)

(72) Inventors: Jonathan D. Young, Jacksonville, FL (US); Nicole D. Young, Jacksonville, FL (US)

(21) Appl. No.: 15/828,542

(22) Filed: Dec. 1, 2017

Related U.S. Application Data
(60) Provisional application No. 62/429,124, filed on Dec. 2, 2016.

(51) Int. Cl. A01K 1/04

(52) U.S. Cl. CPC A01K 1/04; A01K 27/004

(57) ABSTRACT

Apparatuses and methods for restraining a pet are disclosed herein. A portable pet restraint apparatus includes a body with an end section having a cavity with a lower peripheral edge, a suction device mounted to the body with a vacuum-enabling suction component for placement upon an attachment surface, and a force-transmitting shaft attached to the vacuum-enabling suction component and movable to bring the vacuum-enabling suction component between vacuum-disabling and vacuum-enabling conditions relative to the attachment surface. An actuator lever can be pivotable between enabled and disabled positions to move the force-transmitting shaft and vacuum-enabling suction component therewith between the vacuum-disabling and vacuum-enabling conditions. The apparatus can also include a retractable leash device having a length of leash within a leash housing and extendable therefrom.

### RELATED APPLICATION

This disclosure claims priority to previously filed U.S. provisional patent application No. 62/429,124, filed on Dec. 2, 2016, the entire contents of which are hereby incorporated by reference.

### TECHNICAL FIELD

The present invention generally relates to pet confinement without a cage, and, more particularly, to portable pet restraint apparatus embodiments and related method embodiments.

### BACKGROUND

The traditional approach to restraint of animals (e.g., pets, such as dogs) is primarily the use of cages, crates or pens. This approach may cause anxiety and stress to the restrained animal, resulting in barking, mental discomfort, and undesirable behaviors. Additionally, the walls of a pen may tempt the animal to climb up such walls in an attempt to escape the pen. This behavior can result in injury, death and/or unintended escape of the animal from the pen.

One known alternative pet restraint approach provides a device to which a pet owner must temporarily attach a separately provided leash, or other tether component. Such device merely provides a very rudimentary, temporary anchoring point for a pet's leash, for example, providing a structure to which a separate leash may be directly tied or otherwise attached. For instance, such device may merely provide a base which includes a conventional handle having an aperture extending through a portion of the handle. At this aperture, a ring is fixedly attached to the handle. A clasp is provided, permanently attached to the ring, to which another clasp or a loop portion of a separate rope or leash may be attached. A major drawback of this type of device is that it does not provide any means for incorporating a length of a leash (or similar pet tethering device) as part of a portable device itself. Accordingly, a user of such an existing device would be required to carry and provide a suitable length of a leash separately from the anchoring device. Moreover, requiring a user to provide a separate, non-retractable length of leash can create a risk of the pet becoming entangled in that length of leash. And, particularly in applications involving relatively larger pets, the device may not be capable of providing adequate structural reliability.

### SUMMARY

The present disclosure details a number of embodiments relating to pet confinement without a cage. These embodiments can provide a number of useful advantages. For instance, embodiments disclosed herein can provide a portable pet restraint apparatus that allows a pet, such as a dog, to be contained without the sense of confinement typically associated with cages, crates and pens. While at the same time, embodiments of the apparatus disclosed herein can be portable, easy to use, and increase the pet's safety and quality of life.

For example, embodiments disclosed herein can include an apparatus that provides a sturdy attachment mechanism that is less prone to becoming inadvertently detached from an attachment surface. This can include, in certain embodiments, the apparatus incorporating a suction area, embodiments of which are described further herein, that appropriately distributes the force of a pet pulling away from the body of the apparatus.

As another example, in certain embodiments disclosed herein, an apparatus can incorporate an actuator lever and associated structure of the apparatus body. The actuator lever and associated structure of the body can secure the suction area to an attachment surface in a sturdy manner suited for experiencing forces applied by the restrained pet while maintaining the apparatus in place. This actuator lever, while providing a sturdy attachment mechanism, can be actuated by the user in a convenient, easy-to-use manner.

As a further example, apparatus embodiments disclosed herein can incorporate a selectively retractable and extendable length of leash to which a pet (e.g., at a collar thereon) can be easily attached, without requiring that a pet owner carry and provide a separate length of leash. Yet, where a pet owner desires to increase the area within which the apparatus confines the pet, the apparatus has the flexibility to be used with additional length of leash that is attachable to the retractable/extendable length of leash.

One exemplary embodiment includes a portable pet restraint apparatus. The exemplary apparatus can include a body, a suction device, an actuator lever, and a retractable leash device.

In this exemplary apparatus, the body includes an end section. The end section can have a cavity with a lower peripheral edge surrounding a bottom recess.

Also in this exemplary embodiment, the suction device can be mounted to the body and include a vacuum-enabling suction component, a force-transmitting shaft, and a biasing member. The vacuum-enabling suction component (e.g., one or more concave discs) can be configured for placement upon an attachment surface. The force-transmitting shaft can define a longitudinal axis and be attached to and extend upwardly from the vacuum-enabling suction component. The biasing member (e.g., a compression spring, such as a coil spring) can be carried on force-transmitting shaft and have a first end portion seated at the vacuum-enabling suction component and extend therefrom to adjacent (e.g., below) an interior wall portion of the body.

Additionally, in this exemplary embodiment, the actuator lever can be configured to pivot about an axle that defines a cross axis extending in a substantially transverse relationship to the longitudinal axis of the force-transmitting shaft. The actuator lever can be configured to pivot between an enabled position and a disabled position to move the force-transmitting shaft and vacuum-enabling suction component between a vacuum-disabling condition and a vacuum-enabling condition. In the vacuum-disabling condition, the vacuum-enabling suction component can be displaced from the lower peripheral edge to vent the vacuum-enabling suction component from the attachment surface. In the vacuum-enabling condition, the vacuum-enabling suction component can be forced into the bottom recess and into contact with the lower peripheral edge to create a vacuum condition.

Further, in this exemplary apparatus, the retractable leash device can include a leash housing and a length of leash. The leash housing can be at (e.g., interconnected to, contained within, etc.) the body. The length of leash may be retracted within the leash housing and extendable therefrom through an opening in the leash housing.

The number of suction devices that apparatus embodiments disclosed herein include can vary depending on the application of the apparatus. Likewise, the geometry of the body of the apparatus can vary to appropriately accommodate the number of suction devices. While certain embodiments can include a single suction device, some embodiments may include two or more (e.g., a pair of) suction devices. Each such suction device can have an associated actuator lever to switch the apparatus between the vacuum-disabling condition and vacuum-enabling condition as described herein. Depending on the application of the pet restraint apparatus, embodiments including two or more suction devices may function to provide increased distribution of force imparted on the apparatus by the weight of a moving pet (e.g., a dog attempting to pull away from the device). Such embodiments may be useful, for example, where a relatively larger pet is to be restrained by the apparatus. Embodiments of the apparatus including two or more suction devices may prevent non-distributed force (e.g., torque) from a pulling pet to inadvertently dislodge, or otherwise release, the suction device from the attachment surface.

Another exemplary portable pet restraint apparatus embodiment includes a pair of suction devices. In addition to the pair of suction device, this exemplary apparatus embodiment includes a body, a pair of actuator levers, and a retractable leash device.

In this exemplary apparatus, the body can be an arch-shaped hollow body. This body can have a middle section and a pair of opposite end sections affixed to, and extending outwardly and downwardly from, opposite ends of the middle section. Each opposite end section may have a cavity with a lower peripheral edge surrounding a bottom recess.

In this exemplary apparatus, the pair of suction devices can each be mounted at a respective one of the opposite end sections of the hollow body. Each suction device may have a vacuum-enabling concave disc for placement upon an attachment surface. Each suction device may further have a force-transmitting shaft being attached to, and extending upwardly from, the concave disc and movable through an opening of an interior wall portion of the respective one opposite end section of the hollow body and along a longitudinal axis extending lengthwise of the shaft. Each suction device may also have a coil spring installed about the shaft and seated at a lower end upon the concave disc and extending upwardly therefrom to adjacent, and below, the interior wall portion of the respective one opposite end section of the hollow body.

In this exemplary apparatus, the pair of actuator levers can each be disposed within a recess formed in the respective one of the opposite end sections of the hollow body for undergoing pivotal movement about an axle extending across the recess and between opposite sides portions of the respective one opposite end section defining the recess. The axle can define a cross axis being spaced from, and extending in a transverse relationship to, the longitudinal axis of the force-transmitting shaft of a respective one of the suction devices. Each actuator lever can be pivotally movable between a raised position and a lowered position to move the shaft and the concave disc therewith between a vacuum-disabling condition and a vacuum-enabling condition. In the vacuum-disabling condition, the concave disc can be displaced from the lower peripheral edge on the respective one opposite end section of the hollow body to thereby vent the vacuum-enabling concave disc from the attachment surface. In the vacuum-enabling condition, the concave disc can be forced into the bottom recess and into contact with the lower peripheral edge on the respective one opposite end section of the hollow body to create the vacuum condition.

In this exemplary apparatus, the retractable leash device can have a leash housing spaced below the middle section of the hollow body and extending between, and interconnecting, the opposite end sections of the hollow body. A length of leash can be retracted within the leash housing and extendable therefrom through an opening in the leash housing.

Another exemplary embodiment includes a method of restraining a pet. The exemplary method includes actuating an actuator lever. Actuating the actuator lever can move a vacuum-enabling suction component from a vacuum-disabling condition to a vacuum-enabling condition. In the vacuum-disabling condition, the vacuum-enabling suction component can be displaced from a lower peripheral edge of an end section of a body to thereby vent the vacuum-enabling suction component from an attachment surface. When the actuator lever is moved to the vacuum-enabling condition, the vacuum-enabling suction component can be forced into a bottom recess surrounded by the lower peripheral edge to create a vacuum condition. In some cases, actuating the actuator lever can further include moving a force-transmitting shaft, attached to vacuum-enabling suction component, through an opening of an interior wall portion of the end section and compressing a biasing member, carried by the force-transmitting shaft, against the interior wall portion upon moving the force-transmitting shaft. The exemplary method embodiment may further include, in certain instances, coupling a pet to a length of leash that is partially within a leash housing that is at the body. For instance, this length of leash may be configured to be drawn out from an opening in the leash housing when coupled to the pet.

These and other aspects, features, and advantages of the present invention will become more readily apparent from the attached drawings and the detailed description of the exemplary embodiments which follows.

### BRIEF DESCRIPTION OF THE DRAWINGS

Exemplary embodiments of the invention will hereinafter be described in conjunction with the appended drawings provided for illustrative, non-limiting purposes, in which:

FIG. 1 presents a top isometric view of an exemplary embodiment of a portable pet restraint apparatus, showing actuator levers for suction devices of the apparatus disposed in released conditions.

FIG. 2 presents a bottom isometric view of the apparatus originally introduced in FIG. 1.

FIG. 3 presents a top isometric view of the apparatus originally introduced in FIG. 1, but now showing the apparatus installed on an elevated surface with its suction device actuator levers disposed in engaged conditions.

FIG. 4 presents a front elevational view of the apparatus of FIG. 3, now showing the apparatus installed on the elevated surface with a pet coupled to the apparatus's retractable leash.

FIG. 5 presents an enlarged top isometric view of the apparatus of FIG. 3, now showing a lid of the apparatus open and uncovering a cavity for storing items, for instance pet treats or leash extension, within the apparatus.

FIG. 6 presents an enlarged fragmentary longitudinal sectional view of the apparatus showing the one suction device actuator lever at a respective one of the opposite end portions of the apparatus disposed in the released condition.

FIG. 7 presents an enlarged fragmentary longitudinal sectional view of the apparatus as in FIG. 6 but showing the one suction device actuator lever disposed in the engaged condition.

FIG. 8 presents a top isometric view of another exemplary embodiment of a portable pet restraint apparatus, showing an actuator lever for a suction device thereof moving from a released condition to an engaged condition.

FIG. 9 presents a bottom isometric view of the embodiment of the portable pet restraint apparatus in FIG. 8.

FIG. 10 presents an exploded, top isometric view of the embodiment of the portable pet restraint apparatus in FIG. 8.

Like reference numerals refer to like parts throughout the exemplary embodiments illustrated in the drawings.

### DETAILED DESCRIPTION OF EXEMPLARY IMPLEMENTATIONS

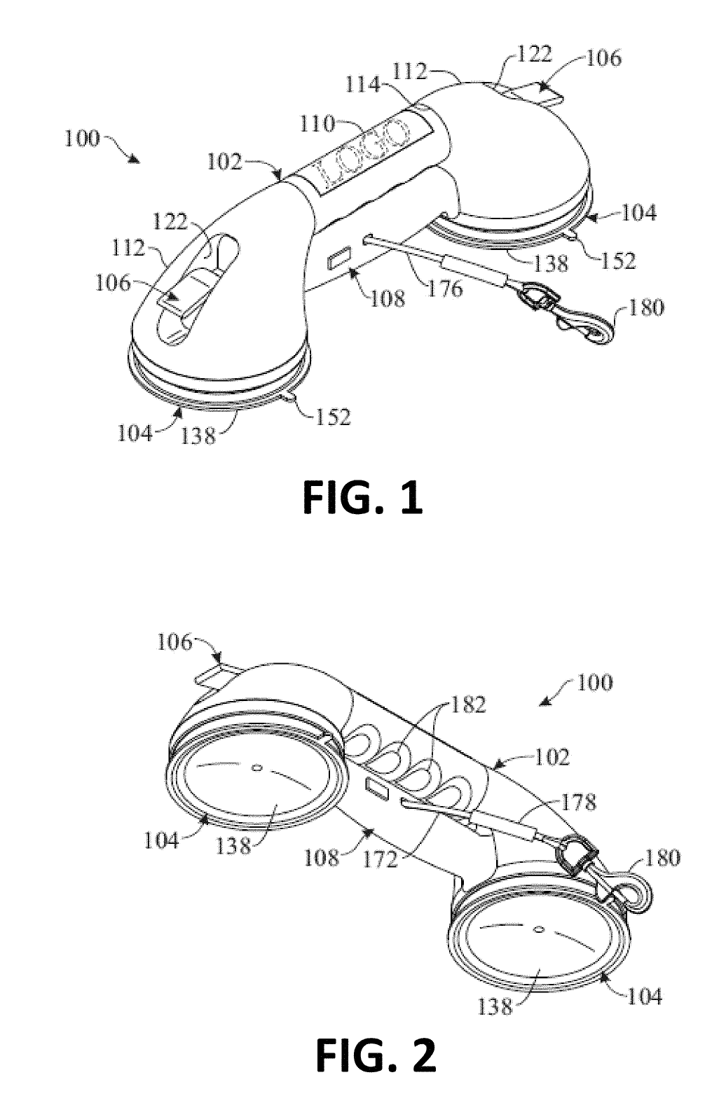

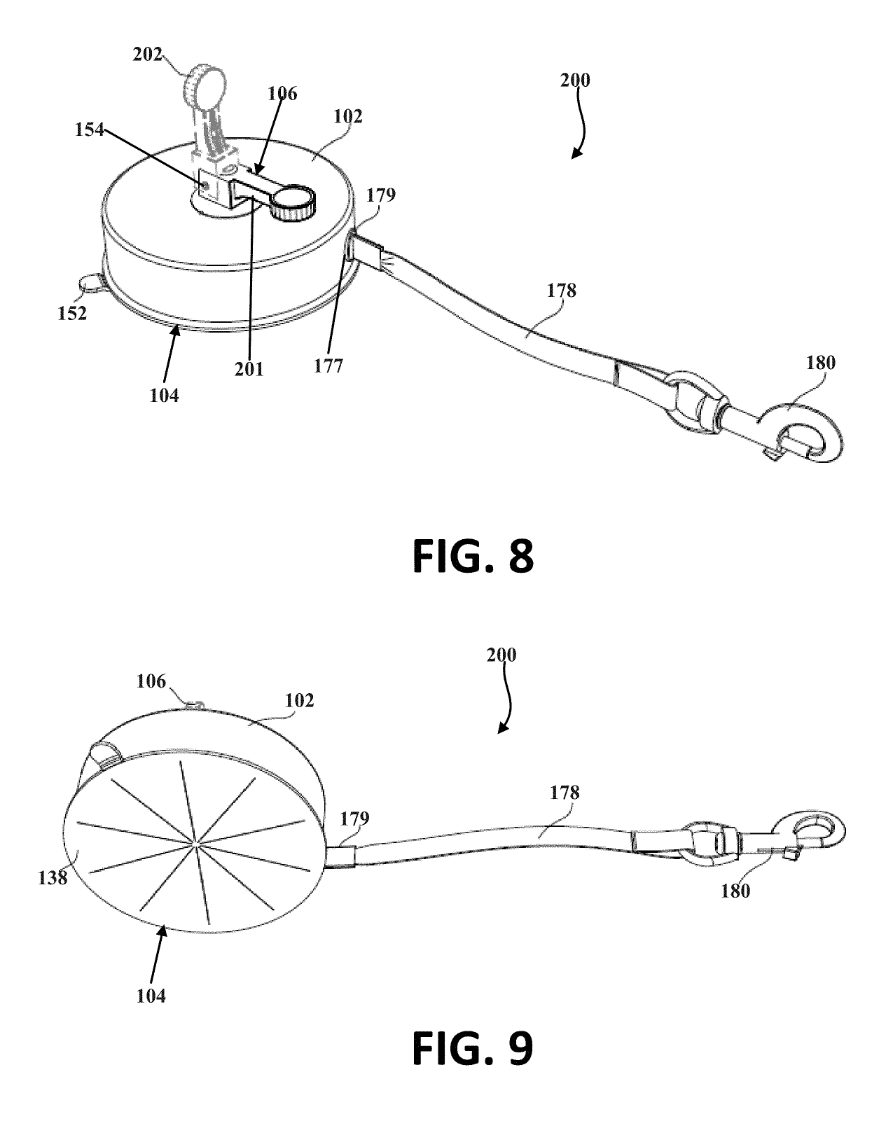

The following detailed description is merely exemplary in nature and is not intended to limit the described embodiments or the application and/or uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1 or 8, as indicated herein. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of concepts defined in the appended claims. Hence, specific dimensions and other physical characteristics relating to the embodiments disclosed herein are not to be considered as limiting, unless the claims expressly state otherwise.

Referring now to FIGS. 1-7, there is illustrated an exemplary embodiment of a portable pet restraint apparatus, generally designated 100. The exemplary apparatus 100 includes a body 102, a pair of suction devices 104, a pair of actuator levers 106, and a retractable leash device 108.

The body 102 of the apparatus 100 is shown here as an arch-shaped hollow body, though it can be embodied in a number of geometries as suited for various applications of the apparatus 100. The body 102 includes a middle section 110 and a pair of opposite end sections 112 affixed to and extending outwardly and downwardly from opposite ends 114 of the middle portion 110. The opposite end sections 112 of the hollow body 102 are mirror images of one another at the opposite ends 114 of the middle portion 110. Also, each opposite end section 112 of the hollow body 102 can have a lower circular wall portion 116 and an upper semi-conical wall portion 118 which merges with and interconnects the lower circular wall portion 116 with the one of the opposite ends 114 of the middle section 110 and defines an interior cavity 120 in each opposite end section 112 and a side recess 122 open to the exterior of the hollow body 102 formed by an interior upper wall portion 124 countersunk into the interior cavity 120. The interior upper wall portion 124 of each respective one of the opposite end sections 112 of the hollow body 102 has an upper opening 126 defined through a ledge 128 of the interior upper wall portion 124. The upper opening 126 is spaced above a lower central opening 130 defined in an interior lower circular wall portion 132 having a downwardly protruding lower peripheral edge 134 forming a bottom recess 136 surrounding the lower central opening 130. The lower central opening 130 establishes communication between the bottom recess 136 and the interior cavity 120.

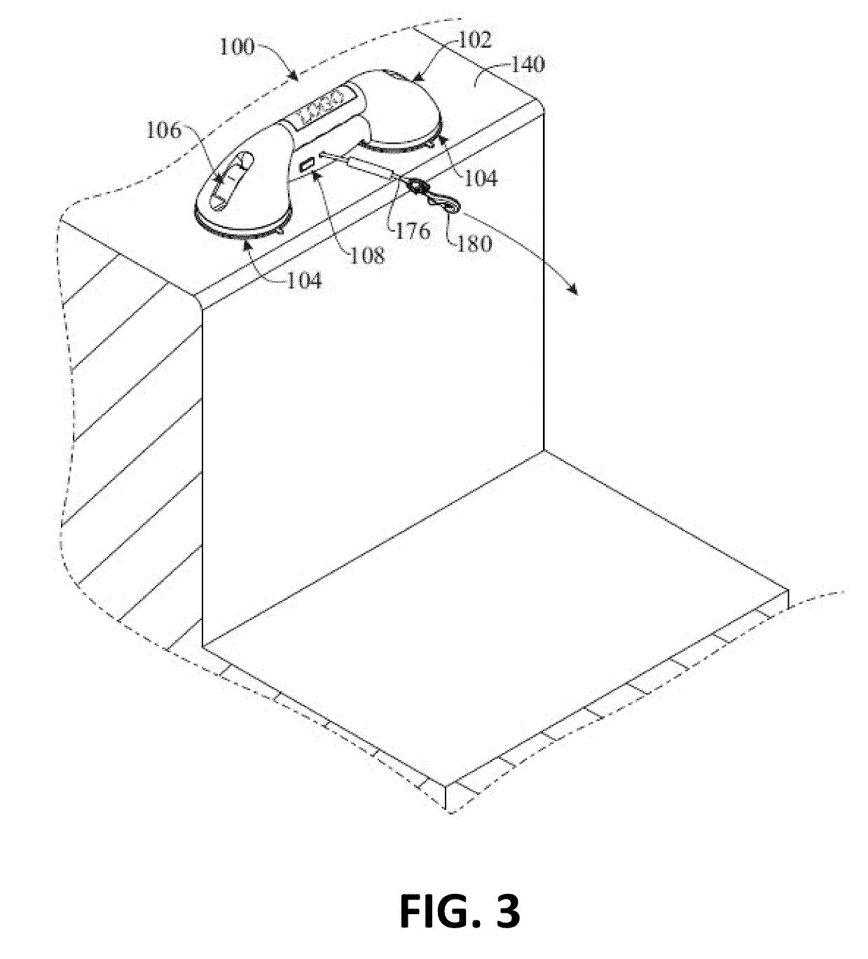

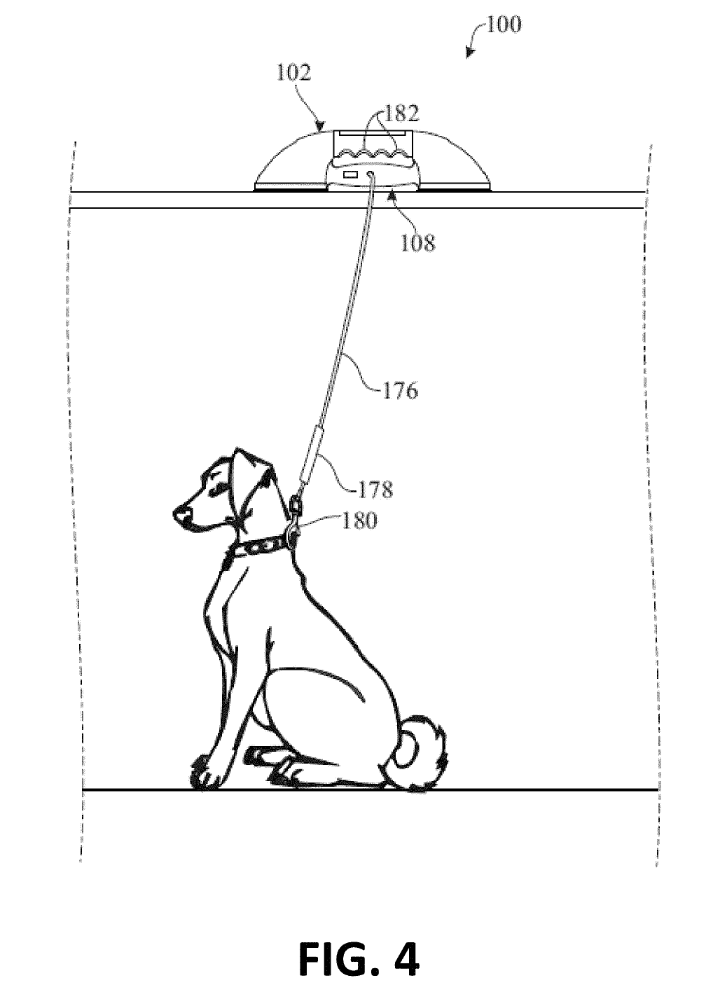

The suction devices 104 of the apparatus 100 are mounted to respective ones of the opposite end sections 112 of the hollow body 102. Each suction device 104 includes a vacuum-enabling suction component 138, shown here as a circular-shaped concave disc, for placement upon an attachment surface 140 (FIGS. 3 and 4). Each suction device 104 also includes an elongated force-transmitting shaft 142 attached to and extending upwardly from a central location on the vacuum-enabling suction component 138 and passing upwardly through the lower central opening 130 defined through the lower circular wall portion 132 and the upper opening 126 defined through the ledge 128 of the interior upper wall portion 124. The force-transmitting shaft 142 is movable along a longitudinal axis 144 extending lengthwise of the shaft 142. Each suction device 104 further includes a biasing member 146 (e.g., a coil spring) installed about the elongated shaft 142. The biasing member 146 has opposite lower and upper ends 148, 150 with the biasing member 146 being seated at its lower end 148 upon the vacuum-enabling suction component 138 at the central location (e.g., of a surface opposite that interfacing with the attachment surface) thereon and extending upwardly therefrom through the lower central opening 130 to proximate and below the ledge 128 of the interior upper wall portion 124 of the respective one opposite end section 112 of the hollow body 102. Also, a tab 152 is attached to and extends radially outward from each vacuum-enabling suction component 138 for the user to grip to assist in release of the vacuum-enabling suction component 138 from the vacuum condition with the attachment surface 140.

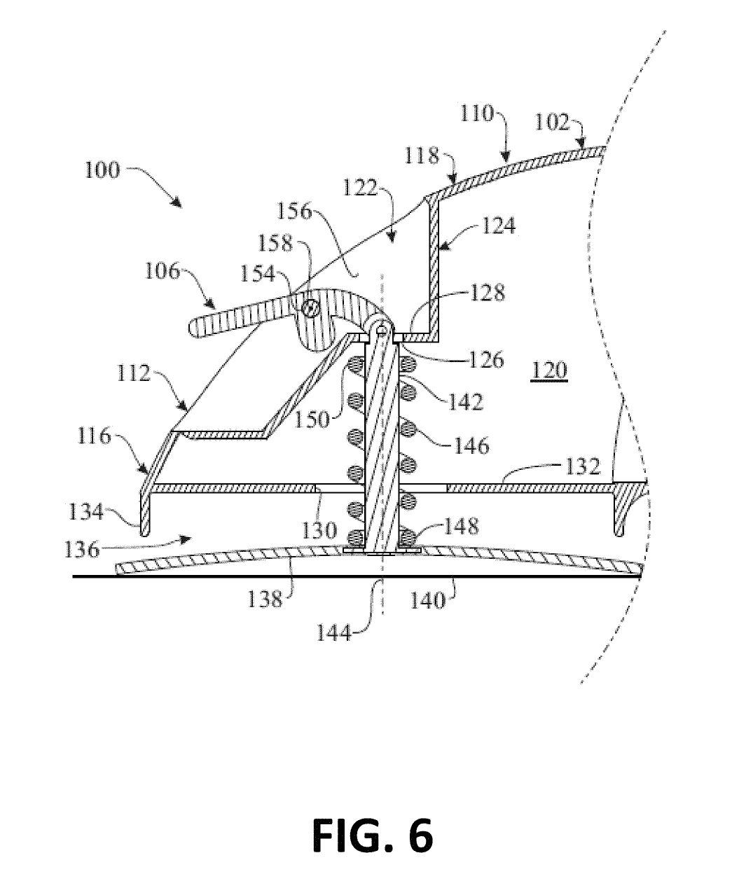

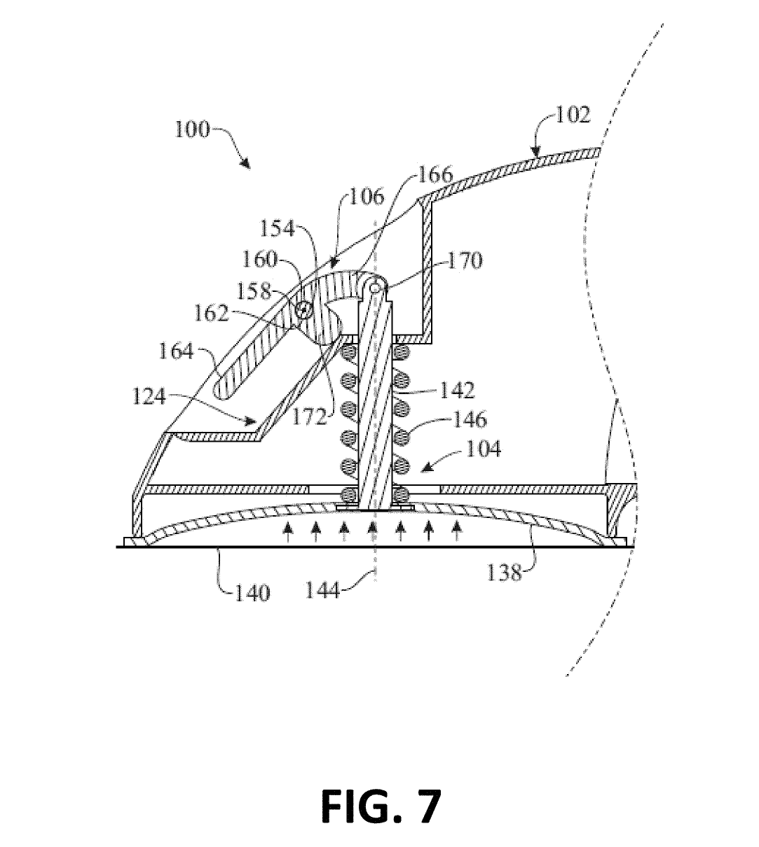

The pair of actuator levers 106 of the apparatus 100 are shown here as disposed within the respective side recesses 122 formed in the opposite end sections 112 of the body 102. Each actuator lever 106 may undergo pivotal movement about an axle 154 extending across the respective side recess 122 and between opposite sides 156 of the interior upper wall portion 124 of the respective one opposite end section 112 defining the respective side recess 122 open to the exterior of the hollow body 102. The axle 154 defines a cross axis 158 being spaced from and extending in a transverse relationship to the longitudinal axis 144 of the force-transmitting shaft 142 of a respective one of the suction devices 104. Each actuator lever 106 includes a middle segment 160 having an aperture 162 receiving the axle 154, a handle 164 affixed to and extending outwardly and rearward from the middle segment 160, a link 166 of arcuate shape affixed to and extending forwardly and downwardly from the middle segment 160 and pivotally coupled at the forward end 168 of the link 166 to an upper end 170 of the force-transmitting shaft 142 of the respective one of the suction devices 104, and a locking lobe 172 affixed to and extending downward from the middle segment 160. The handle 164 may be pivotally moved by a user between enabled (e.g., lowered) and disabled (e.g., raised) positions, as seen in FIGS. 6 and 7, to move the link 166 between such positions and thus move the force-transmitting shaft 142 and vacuum-enabling suction component 138 therewith between vacuum-disabling and vacuum-enabling conditions. This can include compressing the biasing member 146 as the force-transmitting shaft 142 and vacuum-enabling suction component 138 are moved due to the actuator lever 106 being moved between the disabled and enabled positions. The locking lobe 172 is disposed out of contact with the ledge 128 of the interior upper wall portion 124 of the respective one opposite end section 112 of the body 102 when the handle 164 is moved to its raised position, as seen in FIG. 6 in which it extends from the side recess 122, placing the vacuum-enabling suction component 138 at its vacuum-disabling condition which would vent a vacuum condition. In the vacuum-disabling condition, the vacuum-enabling suction component 138 is displaced downwardly from the downwardly protruding lower peripheral edge 134 surrounding the bottom recess 136 of the respective one opposite end section 112 of the body 102. Conversely, the locking lobe 172 is disposed in a condition of forced contact with the ledge 128 when the handle 164 is moved to its lowered position, as seen in FIG. 7 in which it extends within the side recess 122, placing the vacuum-enabling suction component 138 at its vacuum-enabling condition extending into the bottom recess 136 and into forced contact with the lower peripheral edge 134 on the respective one opposite end section 112 of the hollow body 102 to create the vacuum condition. When the actuator lever 106 is moved to its enabled position, as in FIG. 7, an upper portion of the force-transmitting shaft 142 is configured to move out from the cavity 120. When each handle 164 is at its lowered position, as seen in FIG. 7, it is substantially flush with the outer shape of the apparatus 100 and countersunk in the respective side recess 122.

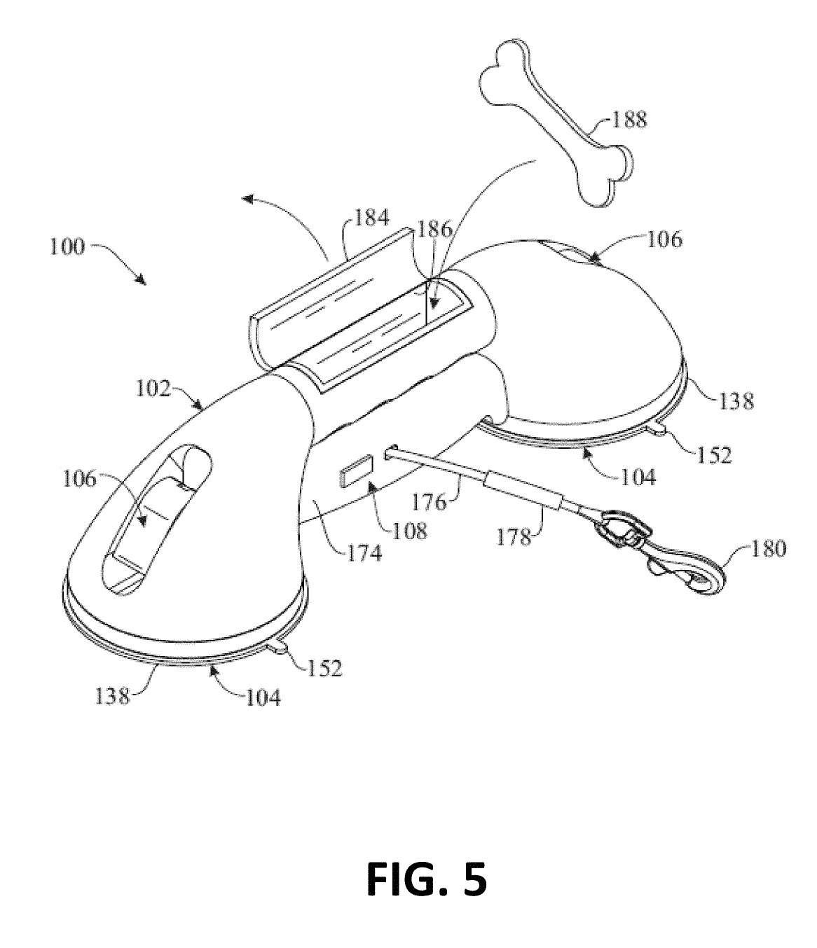

The retractable leash device 108 of the apparatus 100 includes a leash housing 174 at the body 102, shown here as generally tubular in shape and as spaced below the middle section 110 of the body 102 and extending between and interconnecting the opposite end sections 112 of the body 102. The retractable leash device 108 further includes a length of leash 176, such as three to four feet in length, being retracted, at least in part, within the leash housing 174 and extendable therefrom through an opening of the housing. In this way, the retractable leash device 108 can be configured to output a length of leash 176 from the leash housing 174 as force is applied to the leash 176 (e.g., up to the maximum extent of the leash 176) while configured to retract a length of leash 176 into the leash housing 174 when force is removed from the leash 176. The leash 176 has a chew resistant tubular section 178 surrounding it adjacent to a clasp 180 affixed on the outer end of the leash where it can be hooked onto a pet's collar. Also, there is a plurality of finger notches 182 formed on the underside of the middle section 110 of the body 102 of the apparatus 100 and sufficient space provided between the middle section 110 and the leash housing 174 to allow insertion of the fingers of the user's hand through the space and within the finger notches 182 for gripping the middle section of the hollow body. In FIG. 5 an opened lid 184 to a cavity 186 in the middle section 110 is shown for storing a pet treat 188 or further leash extension within the apparatus 100.

The above-described portable pet restraint apparatus 100 with the pair of suction devices 104 and built-in retractable leash device 108 will allow the user to adjust the leash to an appropriate length dispensed from a secured base location at the attachment surface. An adequate distribution of weight dispersed by the apparatus 100 by the pair of suction devices 104 humanely restrains the dog and allows it to be contained without the sense of confinement. Also the retractable leash device 108 may be configured, such as by having an adjustable dial that may be set, to spool out a preselected number of feet in the length of leash, such as from three to seven feet, by the retractable leash device 108. Alternatively, the retractable leash device 108 may be linked to a secondary leash to further lengthen the length of the overall leash. Further, the overall configuration of the apparatus 100 may conform to a particular article, such as a dog bone or a pair of paws.

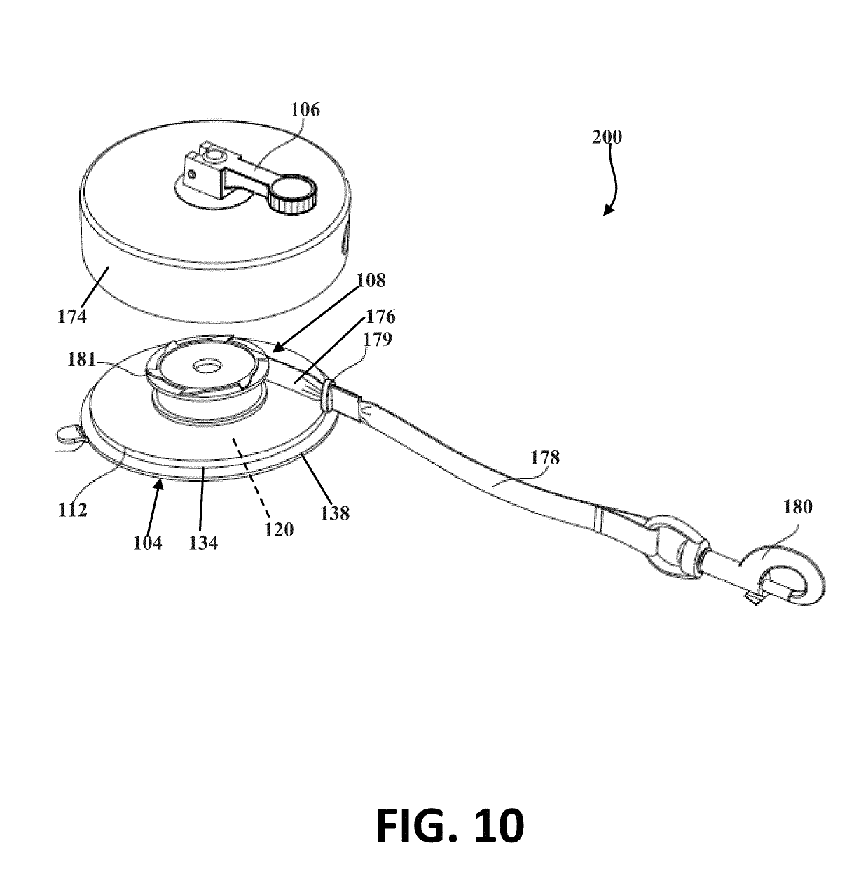

FIGS. 8-10 illustrate another exemplary embodiment of a portable pet restraint apparatus 200. The apparatus 200 is similar to the apparatus 100 previously described except that the apparatus 200 includes a single suction device 104 and associated actuator lever 106. In this way, the apparatus 200 may be suited for application involving confinement of relatively smaller pets. Unless shown or described to be otherwise, the body 102, single suction device 104, and actuator lever 106 of the apparatus 200 can have the same components and operate in the same manner as that shown and described for the apparatus 100 with respect to FIGS. 1-7. For this reason, certain components previously shown and described for the apparatus 100, such as with respect to FIGS. 6 and 7, are not shown for the apparatus 200 but instead referenced to indicate that such components can be the same as that shown and described previously.

The apparatus 200 includes the body 102. The body 102 includes the end section 112. The end section 112 includes the interior cavity 120 with the lower peripheral edge 134 surrounding the bottom recess 136 (shown, e.g., in FIG. 6). The end section 112 of the apparatus 200 can be the same as that shown and described for the end section 112 of the apparatus 100 (e.g., in FIGS. 6 and 7).

The apparatus 200 further includes the suction device 104. The suction device 104 of the apparatus 200 can be the same as that shown as described for the suction device 104 of the apparatus 100 (e.g., FIGS. 6 and 7). Namely, the suction device 104 can be mounted to the body 102, for instance at the end section 112. The suction device 104 can have the vacuum-enabling suction component 138, such as a concave disc as described previously herein. The vacuum-enabling suction component 138 can be configured for placement upon an attachment surface as also described previously herein. The suction device 104 can further include the force-transmitting shaft 142 defining the longitudinal axis 144 and being attached to and extending upwardly from the vacuum-enabling suction component 138 (shown, e.g., in FIGS. 6 and 7). The suction device 104 can also include the biasing member 146 (e.g., a coil spring) carried on the force-transmitting shaft 142 (shown, e.g., in FIGS. 6 and 7). The biasing member 146 can have a first end portion seated at the vacuum-enabling suction component 138 and the biasing member 146 can extend therefrom to adjacent an interior wall portion 124 (shown, e.g., in FIGS. 6 and 7) of the body 102.

The apparatus 200 additionally includes the actuator lever 106 associated with the suction device 104. The actuator lever 106 can be configured to pivot about the axle 154 that defines the cross axis extending in the transverse relationship to the longitudinal axis 144 (shown, e.g., in FIGS. 6 and 7). The actuator lever 106 can be configured to pivot between an enabled position (shown, e.g., at 201) and a disabled position (shown, e.g., at 202) to thereby move the force-transmitting shaft 142 and the vacuum-enabling suction component 138 between the vacuum-disabling condition (shown, e.g., in FIG. 6) and a vacuum-enabling condition (shown e.g., in FIG. 7) similar to that described previously. In the vacuum-disabling condition the vacuum-enabling suction component 138 is displaced from the lower peripheral edge 134 to vent the vacuum-enabling suction component 138 from the attachment surface. In the vacuum-enabling condition the vacuum-enabling suction component 138 is forced into the bottom recess 136 and into contact with the lower peripheral edge 134 (shown, e.g., in FIG. 6) to create a vacuum condition between the vacuum-enabling suction component 138 and the attachment surface.

The apparatus 200 further includes the retractable leash device 108. The retractable leash device can include a length of leash 176 and a leash housing 174, which here is at (e.g., formed by) the body 102. The length of leash 176 can be retracted within the leash housing 174 and extendable therefrom through an opening 177 in the leash housing 174. In this way, the retractable leash device 108 can be configured to output a length of leash 176 from the leash housing 174 as force is applied to the leash 176 (e.g., up to the maximum extent of the leash 176) while configured to retract a length of leash 176 into the leash housing 174 when force is removed from the leash 176. The leash 176 can include the chew resistant section 178 adjacent to the clasp 180 which can be affixed to the pet's collar. As shown, the leash 176 can include a stop member 179 thereon which, for user convenience, can be configured to create an interference fit with the opening 177 to prevent an entire length of the leash 176 from being drawn within the leash housing 174. As also shown, the retractable leash device 108 includes a holding rotor 181. The holding rotor can rotate relative to the leash housing 174 so as to allow the leash 176 to be drawn out from the housing when force is applied to the leash 176 (e.g., when the pet on the leash 176 moves). Thus, the holding rotor 181 may be biased by a relatively small force to draw the leash 176 in to the leash housing 174, up to the stop member 197, and this force can be overcome by movement of the pet to draw the leash 176 out from the leash housing 174. A portion of the leash 176 within the leash housing 174 can wrap around a surface of the holding rotor 181 and thereby act to apply centrifugal force to the holding rotor 181 when the leash 176 is pulled by the pet's movement.

Method embodiments are also within the scope of the present disclosure. One exemplary embodiment includes a method of restraining a pet. The exemplary method includes actuating the actuator lever. Actuating the actuator lever can move the vacuum-enabling suction component from the vacuum-disabling condition to the vacuum-enabling condition. In the vacuum-disabling condition, the vacuum-enabling suction component can be displaced from the lower peripheral edge of an end section of the body to thereby vent the vacuum-enabling suction component from the attachment surface. When the actuator lever is moved to the vacuum-enabling condition, the vacuum-enabling suction component can be forced into the bottom recess surrounded by the lower peripheral edge to create the vacuum condition between the vacuum-enabling suction component and the attachment surface.

In some such method embodiments, actuating the actuator lever can further include moving the force-transmitting shaft, attached to vacuum-enabling suction component, through the opening of the interior wall portion of the end section and compressing the biasing member, carried by the force-transmitting shaft, against the interior wall portion upon moving the force-transmitting shaft.

Further exemplary method embodiments may additionally include, in certain instances, coupling the pet to the length of leash that is partially within the leash housing that is at the body. For instance, this length of leash may be configured to be drawn out from the opening in the leash housing when coupled to the pet.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A portable pet restraint apparatus comprising:
a body including a first end section, the first end section having an interior cavity with a lower peripheral edge surrounding a bottom recess;
a first suction device mounted to the body, the first suction device having a first vacuum-enabling suction component for placement upon an attachment surface, a first force-transmitting shaft defining a first longitudinal axis and being attached to and extending upwardly from the first vacuum-enabling suction component, and a first biasing member carried on the first force-transmitting shaft, the first biasing member having a first end portion seated at the first vacuum-enabling suction component and extending therefrom to adjacent an interior wall portion of the body;
a first actuator lever configured to pivot about a first axle that defines a first cross axis extending in a transverse relationship to the first longitudinal axis, the first actuator lever configured to pivot between a first enabled position and a first disabled position to thereby move the first force-transmitting shaft and first vacuum-enabling suction component between a vacuum-disabling condition and a vacuum-enabling condition, wherein in the vacuum-disabling condition the first vacuum-enabling suction component is displaced from the lower peripheral edge to vent the first vacuum-enabling suction component from the attachment surface, and wherein in the vacuum-enabling condition the first vacuum-enabling suction component is forced into the bottom recess and into contact with the lower peripheral edge to create a vacuum condition; and
a retractable leash device comprising a leash housing at the body and a length of leash being retracted within the leash housing and extendable therefrom through an opening in the leash housing.

2. The apparatus of claim 1, wherein the first biasing member is configured to be compressed against the interior wall portion of the body when the first actuator lever is pivoted from the first disabled position to the first enabled position.

3. The apparatus of claim 2, wherein the first biasing member is a coil spring.

4. The apparatus of claim 2, wherein the first force-transmitting shaft is configured to move along the first longitudinal axis and through an upper opening defined in a ledge of the interior wall portion of the body when the first actuator lever is pivoted from the first disabled position to the first enabled position.

5. The apparatus of claim 4, wherein the first force-transmitting shaft is further configured to move along the longitudinal axis and through the bottom recess when the first actuator lever is pivoted from the first disabled position to the first enabled position.

6. The apparatus of claim 4, wherein an upper portion of the first force-transmitting shaft is configured to move out from the interior cavity when the first actuator lever is pivoted from the first disabled position to the first enabled position.

7. The apparatus of claim 1, wherein the first axle extends across a first recess formed in the first end section of the body and is spaced from the first longitudinal axis.

8. The apparatus of claim 7, wherein the first actuator lever is disposed within the first recess formed in the first end section of the body.

9. The apparatus of claim 1, wherein the first enabled position of the first actuator lever comprises the first actuator lever being in a lowered position and the first disabled position of the first actuator lever comprises the first actuator lever being in a raised position.

10. The apparatus of claim 1, wherein the body further comprises a second end section and a middle section, the first end section and the second end section being affixed to and extending outwardly and downwardly from opposite ends of the middle section.

11. The apparatus of claim 10, further comprising a second suction device mounted to the body, the second suction device having a second vacuum-enabling suction component for placement upon the attachment surface, a second force-transmitting shaft defining a second longitudinal axis and being attached to and extending upwardly from the second vacuum-enabling suction component, and a second biasing member carried on the second force-transmitting shaft, the second biasing member having a second end portion seated at the second vacuum-enabling suction component and extending therefrom to adjacent the interior wall portion of the body.

12. The apparatus of claim 11, wherein the first suction device is mounted at the first end portion of the body and the second suction device is mounted at the second end portion of the body.

13. The apparatus of claim 11, further comprising a second actuator lever configured to pivot about a second axle that defines a second cross axis extending in a transverse relationship to the second longitudinal axis, the second actuator lever configured to pivot between a second enabled position and a second disabled position to thereby move the second force-transmitting shaft and second vacuum-enabling suction component between the vacuum-disabling condition and the vacuum-enabling condition.

14. The apparatus of claim 13, wherein the second axle extends across a second recess formed in the second end section of the body and is spaced from the second longitudinal axis.

15. The apparatus of claim 10, wherein the leash housing of the retractable leash device is attached to the body below the middle section.

16. The apparatus of claim 1, wherein the leash housing of the retractable leash device is formed by the body.

17. The apparatus of claim 1, wherein the first vacuum-enabling suction component comprises a concave disc.

18. The apparatus of claim 1, wherein the body further comprises a lid configured to open a storage cavity defined within the body.

19. A method of restraining a pet, the method comprising the steps of:
actuating an actuator lever to move a vacuum-enabling suction component from a vacuum-disabling condition to a vacuum-enabling condition, wherein in the vacuum-disabling condition the vacuum-enabling suction component is displaced from a lower peripheral edge of an end section of a body to thereby vent the vacuum-enabling suction component from an attachment surface, and wherein in the vacuum-enabling condition the vacuum-enabling suction component is forced into a bottom recess surrounded by the lower peripheral edge to create a vacuum condition between the vacuum-enabling suction component and the attachment surface; and
coupling pet to a length of leash that is partially within a leash housing at the body, wherein the length of leash is configured to be drawn out from an opening in the leash housing when coupled to the pet.

20. The method of claim 19, wherein actuating the actuator lever to move the vacuum-enabling suction component from the vacuum-disabling condition to the vacuum-enabling condition further includes moving a force-transmitting shaft, attached to the vacuum-enabling suction component, to thereby compress a biasing member, carried by the force-transmitting shaft, against an interior wall portion.
